(19) United States
(12) Patent Application Publication
(10) Pub. No.: US 2019/0371115 A1
(43) Pub. Date: Dec. 5, 2019

(54) INSTANT GAME TICKET WITH CHANGEABLE PRICING

(71) Applicant: Kathleen Nylund Jackson, Newport, NC (US)

(72) Inventor: Kathleen Nylund Jackson, Newport, NC (US)

(21) Appl. No.: 16/542,653

(22) Filed: Aug. 16, 2019

(51) Int. Cl. G07F 17/32; A63F 3/06

(52) U.S. Cl. CPC G07F 17/329; A63F 3/0665; A63F 3/0605

(57) ABSTRACT

A method of playing a lottery instant scratch ticket game comprises a plurality of physical tickets, wherein each ticket provides one initial price point and a gameplay element wherein the initial price point may change. Multiple jackpot amounts may be provided.

### RELATED APPLICATION DATA

This Application claims priority from U.S. Provisional Patent Application Ser. No. 62/869,124, filed Jul. 1, 2019, and having the Title INSTANT GAME TICKET WITH CHANGEABLE PRICING.

### BACKGROUND OF THE INVENTION

### 1. Field of the Invention

The present invention relates to an instant game ticket (otherwise known in the art as a “scratch ticket”). The invention further relates to lottery gaming wherein the physical instant game ticket may be purchased and verified at a lottery agent location or other suitable locations, the ticket utilizing a gameplay that provides a chance to change the initial price of the ticket. An electronic version is also disclosed.

### 2. Background of the Art

For nearly 50 years, instant game tickets, or scratch tickets as in known in the art, have been offered for sale as part of city, state, and national lotteries. These tickets typically have an array of winning numbers and an array of player numbers, each concealed with a removable film. The player scratches off the film to reveal the numbers. If a player number matches a winning number, a prize is won.

Scratch ticket games are provided wherein a predetermined number of tickets are printed, each ticket providing either a losing result or a winning result. The amount of tickets with losing results is predetermined, as are the number of tickets with winning results. Also predetermined is the number of tickets for each individual win amount. The total amount of awards of the winning tickets will be less than the total cost of all tickets in the game. For instance, a total of 90,720,000 $5 tickets may be printed and sold. The total ticket sales will be $453,600,000. The total payout to players may be $345,471,000.

Scratch tickets (otherwise known as instant tickets or scratchers) have gained considerable popularity since they provide a near instant gratification; that is, the result can be determined in mere seconds. Scratch tickets are available in different denominations, with the value of the prizes, including jackpot prizes, increasing as the price of the ticket increases. Players can choose a price point that is within their comfort level of risk, but may be discouraged that the corresponding prizes are smaller than they would like.

In order to keep the incentive to play fresh and appealing, new versions of the instant ticket have been created. Various attempts have been made to create new instant games and gameplay in order to increase player participation and excitement.

U.S. Pat. No. 8,512,123 (Stanek, et al.) teaches a method and associated lottery game card/ticket for implementing a ticket-based, multi-component lottery game and includes providing lottery tickets for players, wherein the lottery tickets include a first game component with a first prize structure and at least one additional game component with a separate second prize structure. A first validation code is provided on the lottery ticket that is linked to a first game server for validating and redeeming the first game component of the lottery ticket. A second validation code is provided on the lottery ticket that may be linked to a separate second game server for validating and redeeming the second game component of the lottery ticket. Validation and redemption of the lottery ticket for the first and second game components is enabled by separate redemption acts.

U.S. Pat. No. 8,298,063 (Packes, et al.) discloses some systems, processes, apparatus and articles of manufacture that provide for selling lottery entries. In one example, a request is received to purchase a multiplier and a set of play indicia for a lottery game.

U.S. Pat. No. RE34,673 (Desbiens) describes a two-level scratch game which comprises a substrate on which is printed a first grid of randomly selected numbers, each number being printed in a separate box which forms part of the grid. At least one instant prize in the form of a prize amount or of a game symbol is printed in at least one of the boxes of the first grid. A scratchable rub-off coating is applied onto the first grid to hide the numbers and instant prizes printed in the boxes of this first grid. A second grid identical in size to the first grid and containing the same randomly selected numbers is printed on the rub-off coating exactly over the first grid. In use, a player owning the game will benefit from two levels of playing activity upon a drawing of numbers at random by an authorized authority, namely (1) to try to get a complete horizontal, vertical or diagonal row of numbers as in a Bingo game in order to win a given prize, and simultaneously (2) to scratch the boxes containing the drawn numbers in order to find and win an instant prize. A method of manufacturing this two-level scratch game is also disclosed.

U.S. Pat. No. 8,628,082 (Martineck) describes a lottery instant-game ticket and method of making same. On a substrate is placed a first set of game indicia including a first set of game symbols, and a second set of indicia larger than the first set of game indicia and including a second set of game symbols, and includes any winning symbol. A subset of the second set of game indicia with each symbol includes a non-winning indicator. The first set and second of game indicia are covered with a removable covering, with the covering having position indicators positioned substantially over each of the first set of game indicia, and identical game symbols positioned substantially over a corresponding identical game symbol of the second set of game indicia such that removal of the identical game symbol reveals the identical game symbol of the second set of game indicia and any non-winning indicator, if present.

Each of the references discussed in this text art are incorporated herein in their entirety for all purposes.

It is an ever-increasing challenge to provide players with new and enticing gameplay features that will stimulate player interest and increase participation in instant lottery games. It would be advantageous to provide inventive elements for an instant scratch ticket that provide multiple amounts of wins and jackpot wins for each prize level not usually seen in a typical scratch ticket game. In addition, it would be beneficial to provide a ticket that would appeal to players who would like to play a higher denomination ticket, but feel uncomfortable risking more money.

### SUMMARY OF THE INVENTION

The present invention discloses a method of playing a lottery instant scratch ticket game comprised of a plurality of physical tickets, in which each ticket provides an initial price point shown by an initial price indicium. A final price point shown by a final price indicium is initially covered by an opaque removable film. The final price point may be the same as the initial price point, or the final price point may differ from the initial price point. A first paytable is provided for the initial price point. At least a second paytable is provided for a final price point that differs from the initial price point. An array of winning symbols is determined from a predetermined set of symbols. The winning symbols may be printed on the ticket and covered by an opaque removable film, or a predetermined array of winning symbols may be indicated and explained on the ticket. At least one array of player symbols from the predetermined set of symbols is provided and covered by a removable film (either opaque or transparent). If at least one player symbol is found to match a winning symbol, or if an array of player symbols is found to match an array of winning symbols, a prize will be awarded. The opaque removable film covering the final price point is removed by scratching off the film, revealing the final price point. Any prize is awarded according to either the first paytable or the at least second paytable.

### BRIEF DESCRIPTION OF THE FIGURES

FIG. 1A shows an instant scratch ticket containing the game elements for a game utilizing the game technology described in a first preferred embodiment of the present invention herein.

FIG. 1B refers to FIG. 1A and shows winning symbols, player symbols and a price indicator being revealed by scratching off the opaque film covering each element.

FIG. 2A shows an instant scratch ticket containing the game elements for a game utilizing the game technology described in a second preferred embodiment of the present invention herein.

FIG. 2B refers to FIG. 2A and shows player symbols and a price indicator being revealed by scratching off the opaque film covering each element.

### DETAILED DESCRIPTION OF THE INVENTION

A first preferred embodiment of the present invention describes an instant lottery ticket and method of conducting a lottery instant scratch ticket game comprising: a) providing a plurality of physical scratch tickets; b) providing an initial price indicium on each ticket; c) providing a final printed price indicium from a predetermined set of final price indicia on each ticket wherein the final price indicium is covered by a removable opaque film; d) revealing the final printed price indicium by scratching off the opaque film covering the final price indicium; e) providing an array of winning symbols from a predetermined set of symbols; f) providing an array of player symbols from the predetermined set of symbols; g) providing a first predetermined paytable based on the initial price indicium; h) providing at least a second predetermined paytable based on the final printed price indicium if the final printed price indicium differs from the initial price indicium; i) determining a prize if a player symbol matches a winning symbol; j) providing the prize based on the first paytable if the final printed price indicium matches the initial price indicium; and k) providing the prize based on at least the second paytable if the final printed price indicium differs from the initial price indicium.

The said first preferred embodiment of the present invention discloses a lottery game in which a plurality of instant scratch tickets is provided. A wager of cash, credits or non-monetary points may be required to play the game. The name of the game is shown on the ticket. Preferably, a printed verification code is provided and is concealed underneath an opaque film. The said verification code provides an encryption that guarantees that the ticket is valid and maintains the authenticity of the instant game ticket. The price of the ticket is provided as the initial price that the player pays for the ticket. As an example, the initial price may be $3. A final price of the ticket is printed directly on the ticket card, covered by a removable opaque film, and is preferably a higher price than the initial price. To continue the example, the final price may be either $5 or $10. Preferably the initial price is printed on the opaque film covering the final price, although it is contemplated that the initial price is printed directly on the ticket card in an area separate from the final price. An array of winning symbols from a predetermined set of symbols, preferably numerals, is printed on the ticket card and is covered by a removable opaque film. An array of player symbols from the predetermined set of symbols is printed on the ticket card and is covered by a removable opaque film. One special symbol from a predetermined set of special symbols is associated with and printed next to each player symbol, and is also covered by the opaque film. Preferably the special symbols are shapes such as a circle, a square, a heart, a triangle, etc., although the special symbols may be icons, numbers, letters, colors or the like. Instructions on how to play the game are provided. The player scratches off the opaque films covering the winning symbols and the player symbols to reveal the said symbols. Any match between a winning symbol and a player symbol is a win, and the special symbol associated with the said player symbol is utilized to determine the value of the win. The player scratches off the opaque film covering the final price to reveal the final price. A predetermined paytable is provided, comprising win amounts for the initial ticket price as well as win amounts for the final price if the final price differs from the initial price. In said first preferred embodiment of the present invention, the paytable comprises a row for each of the set of special symbols and a column for the initial price and any final prices available on the ticket (in the case of said example above, the paytable would have a column for $3 ticket pays, $5 ticket pays and $10 ticket pays). Any win is paid according to the predetermined paytable. Any winning ticket (according to a verification code) is then reverified by processing the ticket through a computer terminal comprised of at least a ticket input device and a computer processor at a lottery agent location or other suitable locations.

A second preferred embodiment of the present invention describes an instant lottery ticket and method of conducting a lottery instant scratch ticket game comprising: a) providing a plurality of physical scratch tickets; b) providing an initial price indicium on each ticket; c) providing a final printed price indicium from a predetermined set of final price indicia on each ticket wherein the final price indicium is covered by a removable opaque film; d) revealing the final printed price indicium by scratching off the opaque film covering the final price indicium; e) indicating at least one predetermined array of winning symbols from a predetermined set of symbols; f) providing at least one array of player symbols from the predetermined set of symbols; g) providing a first predetermined paytable based on the initial price indicium; h) providing at least a second predetermined paytable based on the final printed price indicium if the final printed price indicium differs from the initial price indicium; i) determining a prize if the player symbols match a predetermined array of winning symbols; j) providing the prize based on the first paytable if the final printed price indicium matches the initial price indicium; and k) providing the prize based on at least the second paytable if the final printed price indicium differs from the initial price indicium.

The said second preferred embodiment of the present invention discloses a lottery game in which a plurality of instant scratch tickets is provided. A wager of cash, credits or non-monetary points may be required to play the game. The name of the game is shown on the ticket. Preferably, a printed verification code is provided and is concealed underneath an opaque film. The said verification code provides an encryption that guarantees that the ticket is valid and maintains the authenticity of the instant game ticket. The price of the ticket is provided as the initial price that the player pays for the ticket. As an example, the initial price may be $3. A final price of the ticket is printed directly on the ticket card, covered by a removable opaque film, and is preferably a higher price than the initial price. To continue the example, the final price may be either $5 or $10. Preferably the initial price is printed on the opaque film covering the final price, although it is contemplated that the initial price is printed directly on the ticket card in an area separate from the final price. An explanation of at least one predetermined winning symbol array from a predetermined set of symbols is indicated and printed on the ticket. At least one array of player symbols from the predetermined set of symbols is printed on the ticket card and is covered by a removable opaque film. The predetermined set of symbols may preferably comprise shapes such as a circle, a square, a heart, a triangle, etc., although the symbols may be icons, numbers, letters, colors or the like. Instructions on how to play the game are provided. The player scratches off the opaque film covering the player symbol array(s) to reveal the said symbols. If a player symbol array corresponds exactly to the explanation of a winning symbol array, a winning event is achieved. The player scratches off the opaque film covering the final price to reveal the final price. A predetermined paytable is provided, comprising win amounts for the initial ticket price as well as win amounts for the final price if the final price differs from the initial price. In said second preferred embodiment of the present invention, the paytable comprises a row for each possible winning event and a column for the initial price and any final prices available on the ticket (in the case of said example above, the paytable would have a column for $3 ticket pays, $5 ticket pays and $10 ticket pays). Any win is paid according to the predetermined paytable. Any winning ticket (according to a verification code) is then reverified by processing the ticket through a computer terminal comprised of at least a ticket input device and a computer processor at a lottery agent location or other suitable locations.

A third preferred embodiment of the present invention discloses an electronic ticket and method of conducting a game that provides an electronic lottery-type ticket displayed on an electronic device that comprises at least a monitor screen, at least an electronic processor, and at least one physical input device, that comprises: a) establishing an initial price for the electronic lottery-type ticket; b) allowing the player to make at least one wager matching the initial price of the ticket by utilizing the at least one physical input device; c) providing a final price indicium from a predetermined set of final price indicia on each ticket wherein the final price indicium is initially concealed by an electronic opaque layer; d) revealing the final price indicium by removing the opaque layer concealing the final price; e) indicating an array of winning symbols from a predetermined set of symbols on a first layer wherein the winning symbols may be covered by a second layer; f) displaying an array of player symbols from the predetermined set of symbols on a first layer wherein the player symbols may be covered by at least a second layer; g) providing a first predetermined paytable based on the initial price; h) providing at least a second predetermined paytable based on the final price if the final price differs from the initial price; i) determining a prize if at least one player symbol matches at least one winning symbol; j) providing the prize based on the first paytable if the final price matches the initial price; and k) providing the prize based on at least the second paytable if the final price differs from the initial price. The at least second layers may be either transparent or opaque, and the player may “scratch off” any transparent or opaque layers by utilizing an input device such as a touchscreen, mouse, button or similar tool. Alternately, the “scratch off” process may be provided by the processor.

Reference to the Figures will assist in further understanding of the practice of the present invention.

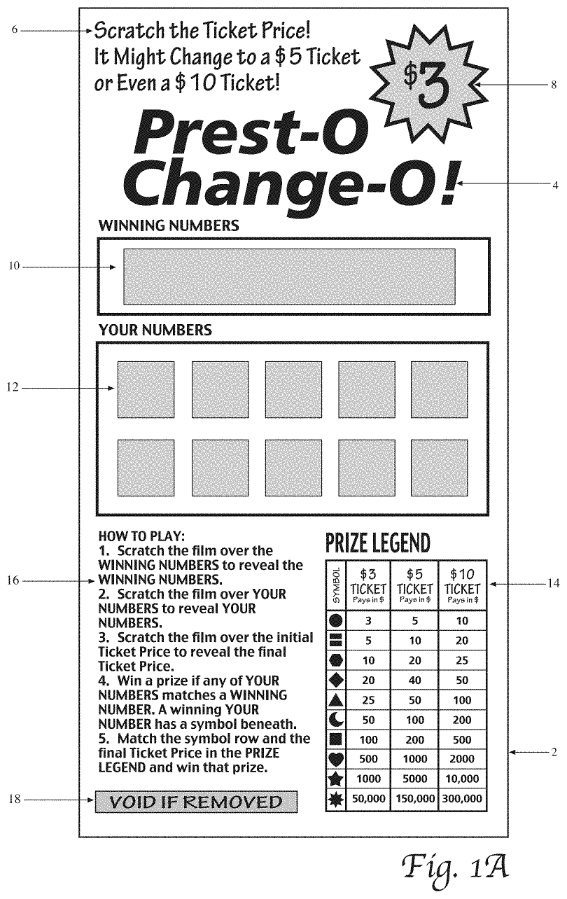

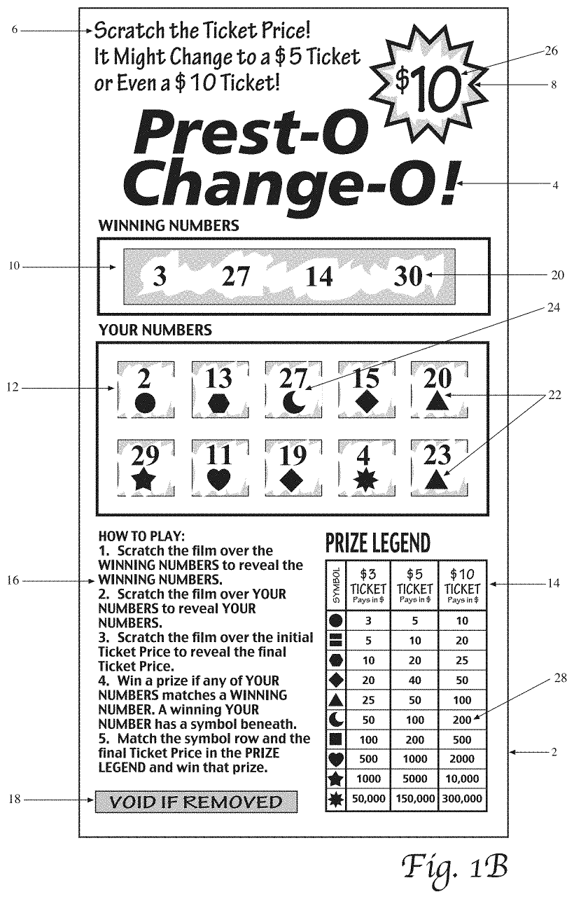

FIG. 1A illustrates the first preferred embodiment of the present invention, providing the elements of present invention that afford the specific gameplay thereof. A physical lottery instant game ticket 2 is provided, comprising a game ticket name 4, and a copy blurb that explains a unique gameplay element 6. An initial price point of the ticket ($3) is printed on a starburst-shaped price indicator 8 that is covered by an opaque film (depicted in grey) so as to conceal a final price point. A boxed area 10 labeled “WINNING NUMBERS” contains winning numbers covered by an opaque film (depicted in grey) so as to conceal the winning numbers. A boxed area 12 labeled “YOUR NUMBERS” contains ten boxes, each comprising a player number and a special symbol, covered by an opaque film (depicted in grey) so as to conceal the player numbers and special symbols. (A special symbol is associated with each player number and printed next to the player number.) A prize legend 14 is provided, comprising a row for each of ten special symbols, a column for the initial price ($3), a column for a first final price ($5) that differs from the initial price and a column for a second final price ($10) that differs from the initial price. “How to Play” gameplay instructions 16 are shown, as well as a concealed verification code 18.

FIG. 1B shows the elements of FIG. 1A wherein the player, according to the gameplay instructions 16, has removed or “scratched off” the opaque film concealing the “WINNING NUMBERS” boxed area 10, revealing four numbers (3, 27, 14 and 30) 20. Also revealed are ten player numbers (2, 13, 27, 15, 20, 29, 11, 19, 4 and 23) with associated special symbols 22. One player number (27) 24 matches a winning number, and the associated symbol is a Half Moon. The player has scratched the starburst-shaped price indicator 8 to reveal the final price ($10) 26. According to the paytable 14, the Half Moon special symbol pays $200 for a $10 final price ticket 28.

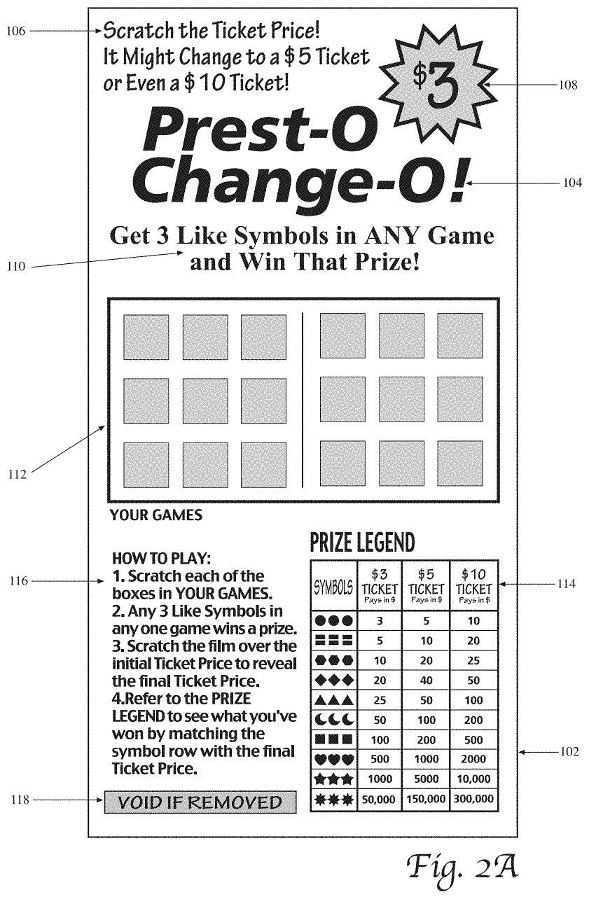

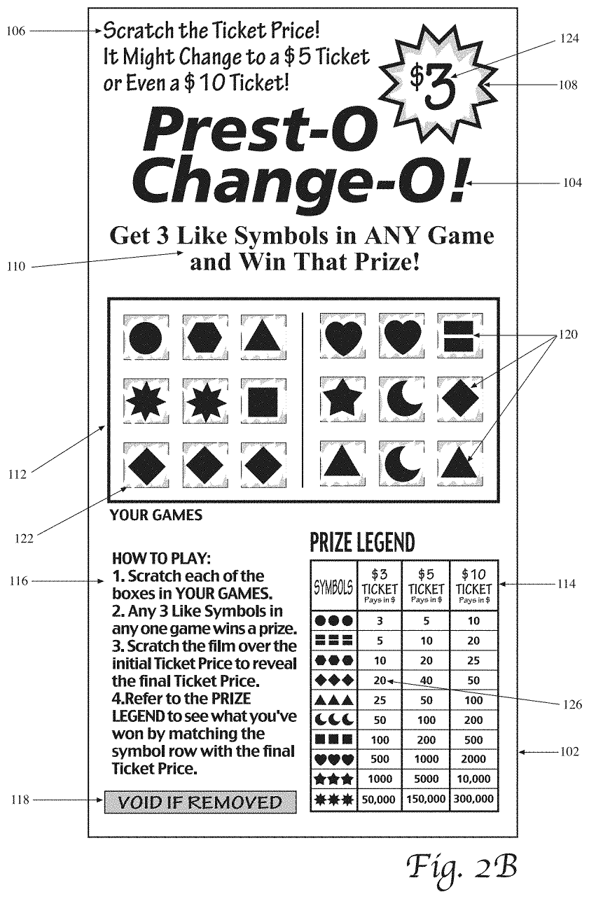

FIG. 2A illustrates the second preferred embodiment of the present invention, providing the elements of present invention that afford the specific gameplay thereof. A physical lottery instant game ticket 102 is provided, comprising a game ticket name 104, and a copy blurb that explains a unique gameplay element 106. An initial price point of the ticket ($3) is printed on a starburst-shaped price indicator 108 that is covered by an opaque film (depicted in grey) so as to conceal a final price point. An explanation of winning arrays of symbols is shown 110. A boxed area 112 labeled “YOUR GAMES” contains six 3-symbol horizontally-disposed games covered by an opaque film (depicted in grey) so as to conceal player symbols. A prize legend 114 is provided, comprising a row for each of ten 3-symbol arrays, a column for the initial price ($3), a column for a first final price ($5) that differs from the initial price and a column for a second final price ($10) that differs from the initial price. “How to Play” gameplay instructions 116 are shown, as well as a concealed verification code 118.

FIG. 2B shows the elements of FIG. 2A wherein the player, according to the gameplay instructions 116, has removed or “scratched off” the opaque film concealing the six 3-symbol games, revealing the players symbols 120 thereof. One player game has three like symbols (Diamond shapes) 122. The player has scratched the starburst-shaped price indicator 108 to reveal the final price ($3) 124. According to the paytable 114, three Diamond shapes pay $20 for a $3 final price ticket 126.

Although specific examples and specific win tables have been provided in this discussion, these specifics are intended to be only support for the generic concepts of the invention and are not intended to be absolute limits in the scope of the technology discussed.

What is claimed:

1. An instant ticket and method of conducting a lottery instant scratch ticket game comprising:
a) providing a plurality of physical scratch tickets;
b) providing an initial price indicium on each ticket;
c) providing a final printed price indicium from a predetermined set of final price indicia on each ticket wherein the final price indicium is covered by a removable opaque film;
d) revealing the final printed price indicium by scratching off the opaque film covering the final price indicium;
e) providing an array of winning symbols from a predetermined set of symbols;
f) providing an array of player symbols from the predetermined set of symbols;
g) providing a first predetermined paytable based on the initial price indicium;
h) providing at least a second predetermined paytable based on the final printed price indicium if the final printed price indicium differs from the initial price indicium;
i) determining a prize if a player symbol matches a winning symbol;
j) providing the prize based on the first paytable if the final printed price indicium matches the initial price indicium; and
k) providing the prize based on at least the second paytable if the final printed price indicium differs from the initial price indicium.

2. The method of claim 1 wherein the initial price indicium is printed on the removable opaque film covering the final printed price indicium.

3. The method of claim 1 wherein the winning symbols are covered by a removable opaque film.

4. The method of claim 3 wherein the winning symbols are revealed by scratching off the opaque film.

5. The method of claim 1 wherein the player symbols are covered by a removable opaque film.

6. The method of claim 5 wherein the player symbols are revealed by scratching off the opaque film.

7. The method of claim 1 wherein the player symbols are covered by a removable transparent film.

8. The method of claim 7 wherein the player symbols are revealed by scratching off the transparent film.

9. The method of claim 1 wherein the final printed price indicium is greater than the initial price indicium.

10. An instant ticket and method of conducting a lottery instant scratch ticket game comprising:
a) providing a plurality of physical scratch tickets;
b) providing an initial price indicium on each ticket;
c) providing a final printed price indicium from a predetermined set of final price indicia on each ticket wherein the final price indicium is covered by a removable opaque film;
d) revealing the final printed price indicium by scratching off the opaque film covering the final price indicium;
e) indicating at least one predetermined array of winning symbols from a predetermined set of symbols;
f) providing at least one array of player symbols from the predetermined set of symbols;
g) providing a first predetermined paytable based on the initial price indicium;
h) providing at least a second predetermined paytable based on the final printed price indicium if the final printed price indicium differs from the initial price indicium;
i) determining a prize if the player symbols match a predetermined array of winning symbols;
j) providing the prize based on the first paytable if the final printed price indicium matches the initial price indicium; and
k) providing the prize based on at least the second paytable if the final printed price indicium differs from the initial price indicium.

11. The method of claim 10 wherein the initial price indicium is printed on the removable opaque film covering the final printed price indicium.

12. The method of claim 10 wherein the player symbols are covered by a removable opaque film.

13. The method of claim 12 wherein the player symbols are revealed by scratching off the opaque film.

14. The method of claim 10 wherein the final printed price indicium is greater than the initial price indicium.

15. An electronic ticket and method of conducting a game that provides an electronic lottery-type ticket displayed on an electronic device that comprises at least a monitor screen, at least an electronic processor, and at least one physical input device, that comprises:
a) establishing an initial price for the electronic lottery-type ticket;
b) allowing the player to make at least one wager matching the initial price of the ticket by utilizing the at least one physical input device;
c) providing a final price indicium from a predetermined set of final price indicia on each ticket wherein the final price indicium is initially concealed by an electronic opaque layer;
d) revealing the final price indicium by removing the opaque layer concealing the final price;
e) displaying an array of winning symbols from a predetermined set of symbols on a first layer wherein the winning symbols may be covered by a second layer;
f) displaying an array of player symbols from the predetermined set of symbols on a first layer wherein the player symbols may be covered by at least a second layer;
g) providing a first predetermined paytable based on the initial price;
h) providing at least a second predetermined paytable based on the final price if the final price differs from the initial price;
i) determining a prize if at least one player symbol matches at least one winning symbol;
j) providing the prize based on the first paytable if the final price matches the initial price; and
k) providing the prize based on at least the second paytable if the final price differs from the initial price.

16. The method of claim 15 wherein at least the second layer is an opaque layer.

17. The method of claim 15 wherein at least the second layer is a transparent layer.

18. The method of claim 15 wherein the player may remove any layer by utilizing an input device such as a touchscreen, mouse, button or similar tool.

19. The method of claim 15 wherein the processor may function to remove any layer without player input.
